(19) United States
(12) Patent Application Publication
(10) Pub. No.: US 2019/0053609 A1
(43) Pub. Date: Feb. 21, 2019

(54) PORTABLE AND ADJUSTABLE HAIRPIECE STAND

(71) Applicant: LaToya Turner, Warren, MI (US)

(72) Inventor: LaToya Turner, Warren, MI (US)

(21) Appl. No.: 16/113,465

(22) Filed: Aug. 27, 2018

Related U.S. Application Data
(63) Continuation-in-part of application No. 15/193,464, filed on Jun. 27, 2016, now Pat. No. 10,149,529.
(60) Provisional application No. 62/550,468, filed on Aug. 25, 2017.

(51) Int. Cl. A45D 44/14; F16M 11/04; F16M 11/16; F16M 11/24

(52) U.S. Cl. CPC A45D 44/14; F16M 11/242; F16M 11/16; F16M 11/04

(57) ABSTRACT

A portable hairpiece stand adapted to hold a plurality of hairpieces to allow for styling. The stand includes: (a) a top base defining a horizontal plate and a plurality of mounting holes; (b) a hairpiece holder detachably mounted on the top base having a plurality of upwardly extending prongs and detachably engaged with a top clamp to hold a plurality of hairpiece between the prongs; (c) an adjustable neck extension operable to adjust a height of the top base; and (d) a lower support base defining a mounting opening for receiving the adjustable neck extension. The lower support base defining one or more receiving channels for retracting and securely fitting a leg operable to slide downward and extend from a lower base body to rest onto a surface and adjust height of the stand.

### CROSS REFERENCE TO RELATED APPLICATION

This application claims priority benefit to U.S. Provisional Application No. 62/550,468 filed Aug. 25, 2017, which is incorporated herein by reference in its entirety. This application is also a continuation-in-part of U.S. patent application Ser. No. 15/193,464 filed Jun. 27, 2016, which is incorporated herein by reference in its entirety.

### TECHNICAL FIELD

The present disclosure relates generally to the field of hair styling tools and more specifically relates to an ultimate hair stand system.

### DESCRIPTION OF RELATED ART

Hairpieces, wigs, and hair extensions are used by many people for a variety of reasons. Hairpieces and wigs are used to conceal baldness, to alter a person's appearance such as might be required for an actor portraying a character, or as a fashion accessory. Hair extensions are used to supplement someone's existing hair to add length, fullness, or a different hair texture.

It is important to maintain the proper hygiene of hairpieces, wigs, and hair extensions to prevent irritation to the wearer and to maintain the aesthetically-pleasing appearance of the hair piece, wig, or hair extensions. To shampoo a hairpiece, wig, or loose hair extensions, a person may hold the item in one hand and apply the shampoo or other cleansing agent with the other hand. After cleaning, the hairpiece, wig, or loose hair extensions are combed while holding them one hand. This process is inefficient and uncomfortable and it is very difficult to use hair styling tools while holding the hairpiece, wig, or loose hair extensions in one hand. In a home, a user may devise an arrangement for holding the wig for washing and styling, but in other situations, for example in a guestroom or a hotel, cleaning and styling of the hair piece, wig, or loose hair extensions is a challenge.

Several attempts have been made to solve the above-mentioned problems such as those found in U.S. Pat. No. 7,703,725 to May; U.S. Pat. No. 5,503,312 to Kassner; U.S. Pat. No. 5,586,696 to Martinez; U.S. Pat. No. 8,439,210 to Griffith; 2006/0008780 to Pang; 2008/0078914 to Liao; 2009/0218376 to King et al.; and 2015/0257515 to Bernard. This art is representative of hair styling tools. However, none of the above disclosures and patents, taken either alone or in combination, is seen to describe the disclosure as claimed.

### SUMMARY

In view of the foregoing disadvantages inherent in the known hair styling tool art, the present disclosure provides a hair stand and hair stand system. The general purpose of the present disclosure, which will be described subsequently in greater detail, is to provide a stand to hold one more hairpieces effectively and conveniently for styling.

In an example, the present disclosure provides for a stand for holding hairpieces for styling. The stand includes an extension having a height adjustment assembly and a height lock. The height adjustment assembly is configured to lockably adjust between a plurality of heights. The stand further includes a base having an anti-skid surface. The anti-skid surface is configured to limit lateral movement of the base across a floor. The base is configured to statically position the height adjustment assembly on the floor. A rack is provided having (i) a hairpiece rack defining a plurality of spaced apart prongs extending upward, and (ii) a corresponding clamp configured to securely hold at least one hairpiece in place within the spaced apart prongs. The rack is coupled to the height adjustment assembly and the prongs extend along a horizontal length defined by the rack such that the at least one hairpiece is securely held in place during styling.

In a further example, the top clamp is removably mounted above the hairpiece rack and the plurality of spaced apart prongs and operable to clamp down and secure a plurality of hairpieces in place between the plurality of prongs. The base can include an extension receiver and the extension can include a rack receiver. The extension receiver is removably-coupleable to the extension.

In yet a further example, the base is configured to have a deployed state and a retracted state and the retracted state is smaller than the deployed state. The base is typically a support base and includes a plurality of legs operable to fold, collapse, and lock. The plurality of legs can include four evenly spaced apart legs surrounding the base and slidably engaging corresponding receiving channels formed on sidewalls of the base. The legs in an extended configuration extend down and outwardly away from the base forming a quad pod.

In yet another example, the extension includes concentric telescoping tubes configured to move between a minimum height and a maximum height. The extension can further include a push-button lock operable to lockably adjust between a plurality of heights by pushing a push-button lock of an inner tube and slidably extending or retracting the inner tube until the push-button lock extends out of one of a plurality of holes of an outer tube. The rack can be configured to securely retain a wig and alternately at least one section of a hair extension.

The present disclosure further provides for a portable hairpiece stand adapted to hold a plurality of hairpieces to allow for styling. The stand includes: (a) a top base defining a horizontal plate and a plurality of mounting holes operable for receiving one or more accessories; (b) a hairpiece holder detachably mounted on the top base having a plurality of upwardly extending prongs and detachably engaged with a top clamp sized and shaped to hold a plurality of hairpiece between the prongs and the top clamp; (c) an adjustable neck extension operable to adjust a height of the top base, the adjustable neck extension including a first adjustable portion movably engaged with a second adjustable portion via a plurality of adjustment holes aligned vertically and a push button formed on the first adjustable portion, the top base removably mounted to a top portion of the second adjustable portion through a connection piece; and (d) a lower support base defining a mounting opening for receiving the adjustable neck extension, the lower support base defining one or more receiving channels for retracting and securely fitting a leg operable to slide downward and extend from a lower base body to rest onto a surface and adjust height of the stand.

In still yet a further example, the lower support base defines an outer sidewall forming four receiving channels surrounding the lower support base and includes four evenly spaced apart legs slidably engaging the corresponding receiving channels. The legs in a splayed configuration extend down and outwardly away from the base forming a quad pod. The receiving channel can further define a receiving locking hole positioned at a lower section of the support base sized and shaped to a protrusion of the leg to hold the legs in a splayed configuration when the protrusion engages the locking hole.

In an example, the hairpiece stand can include a plurality of receiving locking holes aligned within the receiving channel to allow for height variation of the hairpiece stand. In still yet a further example, the top base, the adjustable neck, the hairpiece holder, and the lower support base are detachable from each other and operable to be reassembled. The horizontal plate can include a pair of wing portions for detachably engaging the hairpiece holder through a mounting feature of the hairpiece holder defining a wing portion receiving channel sized and shaped to slide over the wing portions of the horizontal plate. A detachable tool and accessory holder can be mounted to the horizontal plate having an opening cavity for receiving a tool and a plurality of holes formed in a sidewall of the holder. The tool and accessory holder can define a cup configuration sized and shaped to receive a standard hair styling tool. In yet another example, one or more small accessory holders are mounted to the horizontal place through the mounting holes. The top clamp can be formed to engage a security clamp located at an end of the hairpiece holder to hold the top clamp down when holding a hairpiece.

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate embodiments and method(s) of use for the present disclosure.

FIG. 1 shows a perspective view illustrating a hair stand system during an ‘in-use’ condition according to an embodiment of the disclosure.

FIG. 2 is a perspective view illustrating the hair stand system comprising a stand assembly according to an embodiment of the present disclosure of the disclosure.

FIG. 3 is an exploded perspective view illustrating the hair stand system according to an embodiment of the present disclosure.

FIG. 4 is a perspective view illustrating stand assembly according to an alternate embodiment of the present disclosure.

FIG. 5 illustrates a further embodiment of an example hair stand according to the present disclosure from a front side perspective view.

FIG. 6 depicts an exploded view of the hair stand from FIG. 5 from an upper front side view.

FIG. 7 is a top side view of the hair stand from FIG. 5.

FIG. 8 illustrates a retractable quad pod base stand associated with the hair stand of FIG. 5.

FIG. 9 illustrates an exploded view of the hair stand from FIG. 5 from a lower back side view.

The various embodiments of the present disclosure will hereinafter be described in conjunction with the appended drawings, wherein like designations denote like elements.

### DETAILED DESCRIPTION

As discussed above, embodiments of the present disclosure relate to hair styling tools and more particularly to a hair stand device and system as used to improve stands to hold one or more hairpieces for styling.

Generally speaking, a hair stand device and system of the present disclosure may comprise an apparatus used to hold hair extensions, hair bundles and/or wigs. It enables a user to freely style the hairpieces with both hands because the hairpieces hang from a standing clamp. The user may blow dry, flat iron, or curl the hair piece. Moreover, the user is free to maneuver and manipulate the hairpiece with minimized risk of the hairpiece falling off or coming loose. The device is made up of four components with an optional fifth component. The bar clamp is an elongated butterfly-style clamp that holds the hair extension or hair bundle. This allows the hair to spread out so that the user can cater to smaller sections of the hairpiece at a time. An outer pole is combined with a main pole and gives the stand an adjustable height so that the user can utilize it in any capacity, whether sitting or standing. It can have multiple pin holes to allow for an appropriate height. The inner pole locks into the outer pole to secure height for the stand. The tripod base attaches to the inner pole and stabilizes with an adjustable pin screw the inner pole slides inside the outer main pole until the push pin clicks into one of the height-adjusting pin holes, securing it in place. The bar clamp screws on to the main outer pole as well. In this example, the base can be a standard tripod with rubber tips to give the stand sturdy support. The hair stand can be formed to be simple to assemble and with no or few tools required.

The present disclosure provides for a stand for holding a hairpiece at an elevated position to assist in cleaning and dressing of the hairpiece. The stand is operable to hold hair extensions or wigs at an elevated position for cleaning and styling; the stand height is adjustable; the stand is compact and portable and has a case to enclose and carry the stand; and the stand is economical to manufacture.

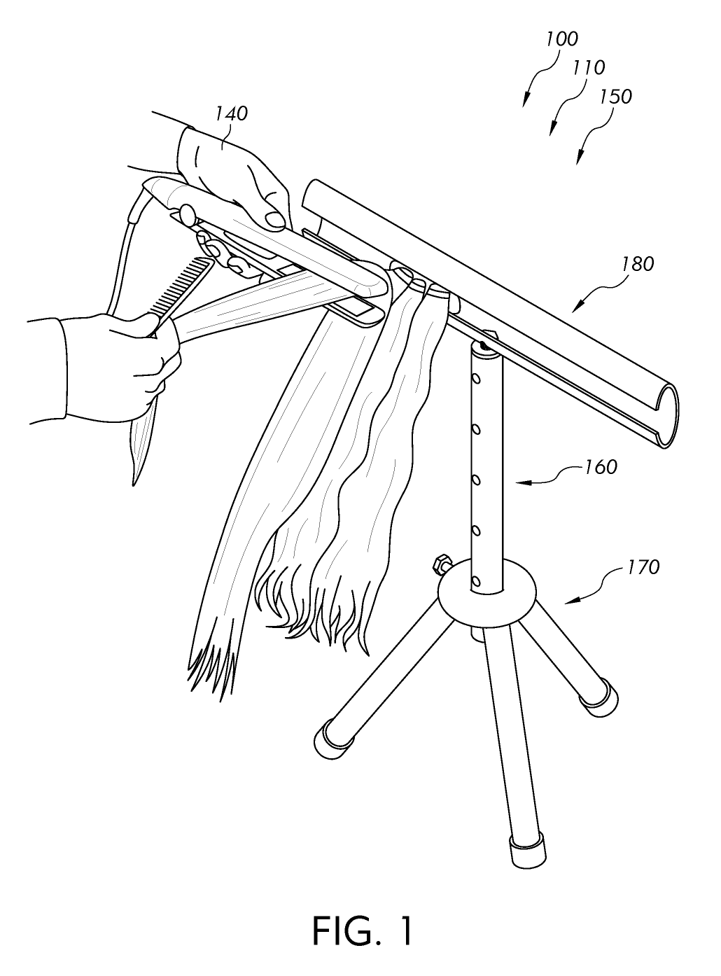

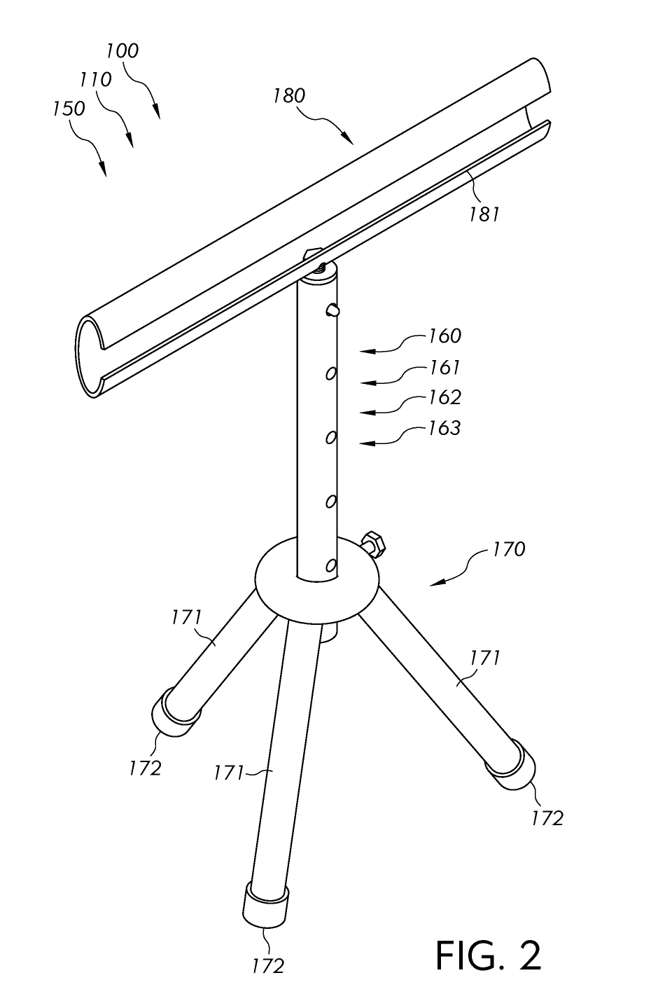

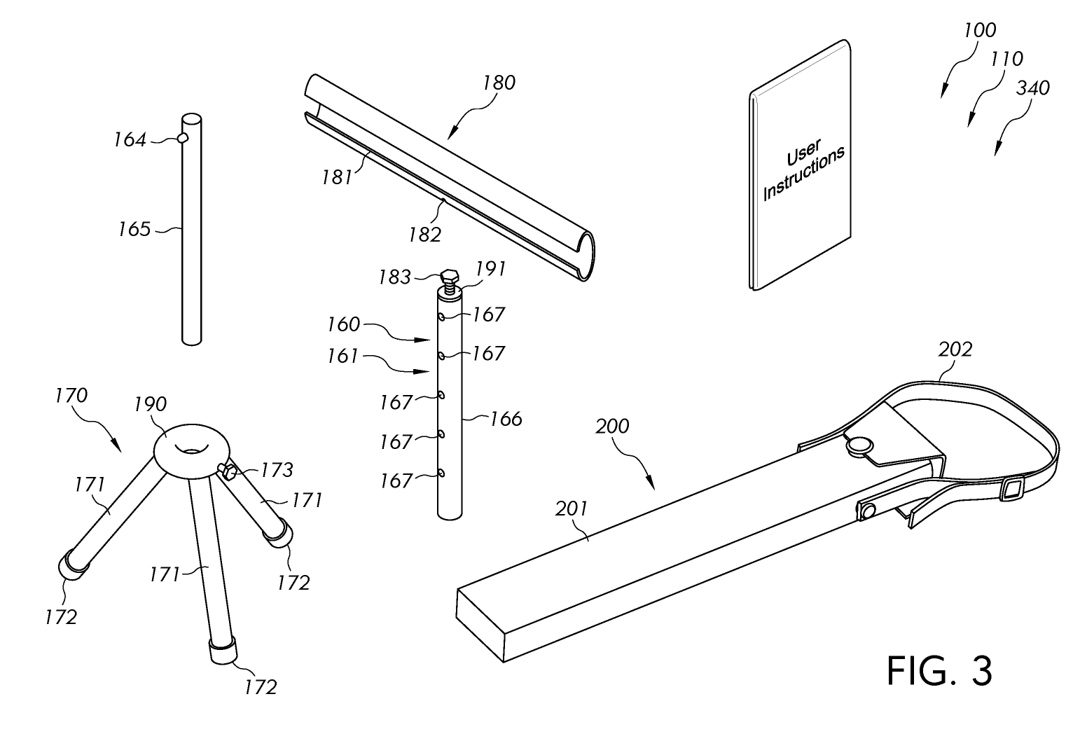

Referring now to the drawings by numerals of reference there is shown in FIGS. 1-4, various views of a hair stand and system of the present disclosure. In an example, portable system 100 is shown for holding one or more hairpieces for user 140 during and ‘in-use’ condition to style hairpieces. Portable system 100 stand 110 may include extension 160, base 170, and rack 180. Extension 160, base 170, and rack 180, in an unassembled condition are configured to be removably-inserted in a box 201 of travel case 200 and transported to a desired location by use of adjustable strap 202.

Extension 160 may be configured as concentric tubes 163. Extension 160 may be configured as a telescopic unit having a minimum height and a maximum height. Extension 160 may be configured to manually move between a minimum height and a maximum height by user 140 and with no or minimal use of tools. Extension 160 may be moved to the minimum height for stowage in the box 201 of the travel case 200. Extension 160 may further have height adjustment assembly 161 including height lock 162. Height adjustment assembly 161 may be configured to lockably adjust between a plurality of heights. Further, extension 160 may include push-button lock 164 that may be configured to lockably adjust between the plurality of heights by pushing push-button 164 lock of inner tube 165 and slidably extending or retracting inner tube 165 until push-button lock 164 extends out of one of plurality of holes 167 of outer tube 166. Extension 160 further includes base receiver 190 and a rack receiver 191. Base receiver 190 and rack receiver 191 are removably-coupleable with extension 160.

Base 170 may be configured to statically position height adjustment assembly 161 on a floor. Base 170 includes legs 171. Legs 171 have anti-skid surface 172 and are configured to fold, collapse, and lock as desired by user 140. Base 170 may further have anti-skid surface 172, with anti-skid surface 172 configured to limit lateral movement of base 170 across a floor. Base 170 may be configured to have a deployed state and a retracted state. The retracted state may be smaller than the deployed state. Legs 171 are held in a deployed splayed condition with adjustment screw 173 for use, and in a stowed condition for stowage in box 201 of travel case 200.

Hairpiece rack 180 may be configured to removably hold a plurality of hairpieces. The plurality of hairpieces may be a hairpiece, a wig, and alternately at least one section of a hair extension 160. Rack 180 may be configured with hole 182 such that screw 183 can be inserted through hole 182 thus be removably-attached to outer tube 166. Rack 180 may further be configured as rail 181 such that at least one hair extension may be slidably-attachable to rail 181 and the at least one hair extension may be serially positioned next to another at least one hair piece. The rail 181 extends along a length of the rack 180 which defines a C-shaped cross section resulting in a C-channel. Rack 180, as shown in FIGS. 1-3, defines an opening for receiving the hairpiece, the opening extending the length of the rack 180. The C-channel is sized and shaped to receive the hairpiece and secure it in place. The rail 181 formed in the C-channel allows for the hairpiece to be adjusted slidably along the length of the rack within the opening. Rack 180 may be further configured to couple to height adjustment assembly 161. Rack 180 may be configured to release the hairpiece, the wig, and alternately the at least one section of a hair extension for stowage of rack 180 in box 201 of travel case 200. Further, rack 180 may be removed from outer tube 166 for stowage in box 201 of travel case 200.

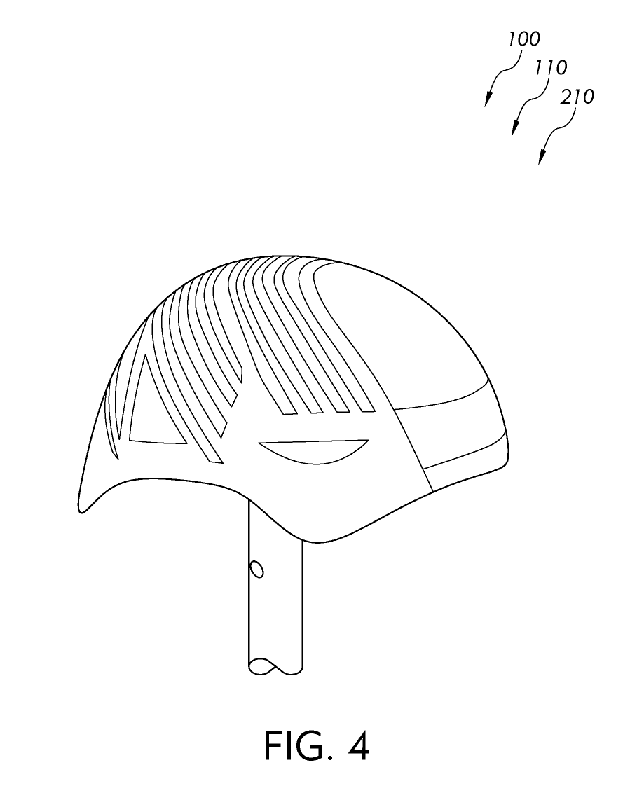

The present disclosure provides for a method of retaining one or more hairpieces during styling. In an example, the method includes the steps of adjusting rack 180 which includes height adjustment assembly 161, hanging at least one section of a hair extension on rack 180, and removing the at least one section of a hair extension 160 from rack 180 when styling is complete. Retaining the at least one hair extension retention on rack 180 includes grasping the fabric strip of the at least one hair extension and slidably-attaching it to rail 181. The at least one hair extension may be slidably-removed when styling is complete. The method may further include retaining the hairpiece and alternatively the wig on alternative embodiment of rack 210 (FIG. 4) of the present disclosure. Alternative embodiment of rack 210 may be able to be removably-attached to extension 160, and the hairpiece and alternatively the wig may be placed on alternative embodiment of the rack 210 and the hairpiece and the wig may be removed from the alternative embodiment of the rack 210 when desired. Upon reading this specification, it should be appreciated that, under appropriate circumstances, considering such issues as user preferences, design preference, structural requirements, marketing preferences, cost, available materials, technological advances, etc., other ultimate hair stand system arrangements such as clips to hold hair, plastic materials for construction, etc., may be sufficient.

Portable system 100 may be provided as a kit 340 comprising the following parts: at least one extension 160; at least one base 170; at least one rack 180; and at least one set of user instructions. The kit has instructions such that functional relationships are detailed in relation to the structure of the disclosure (such that the disclosure can be used, maintained, or the like in a preferred manner).

Portable system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color and height combinations, parts may be sold separately, etc., may be sufficient.

A method of use for portable system 100 may comprise the steps of: step one, unpacking rack 180, base 170, and extension 160 from box 201 of travel case 200; step two, deploying rack 180, when attaching rack 180 follows deployment of extension 160; and step three, unpacking and deploying legs 171 by extending and holding legs 171 in a splayed condition with adjustment screw 173.

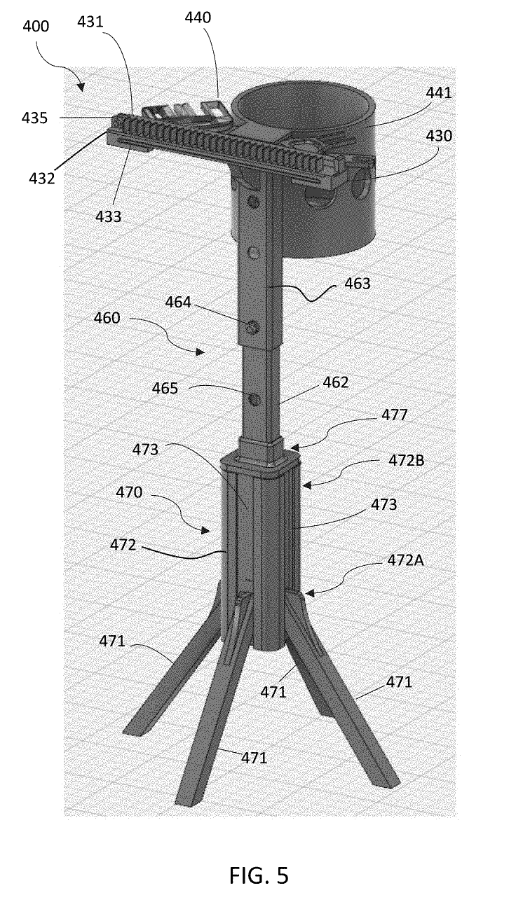

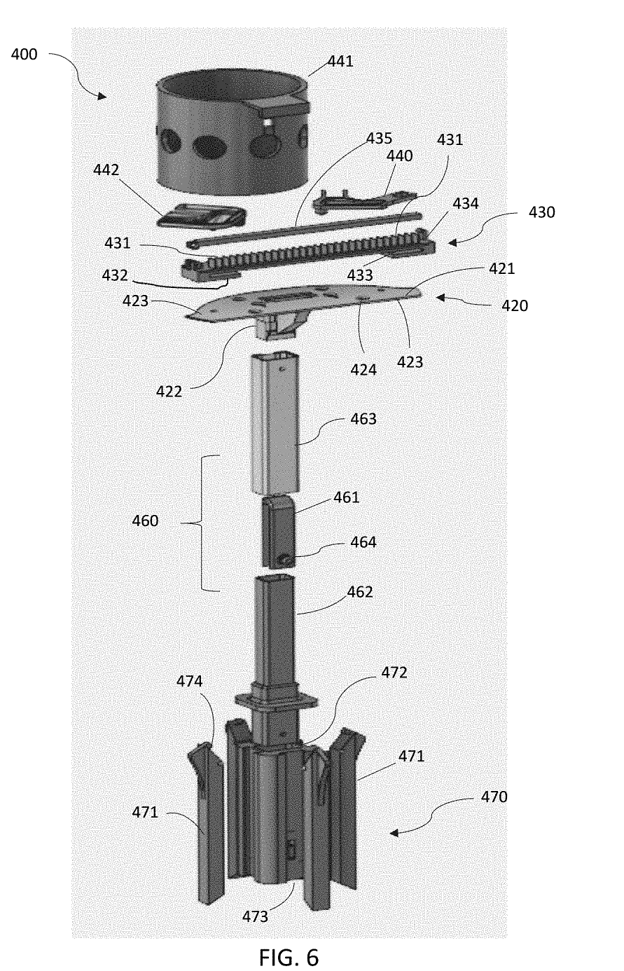

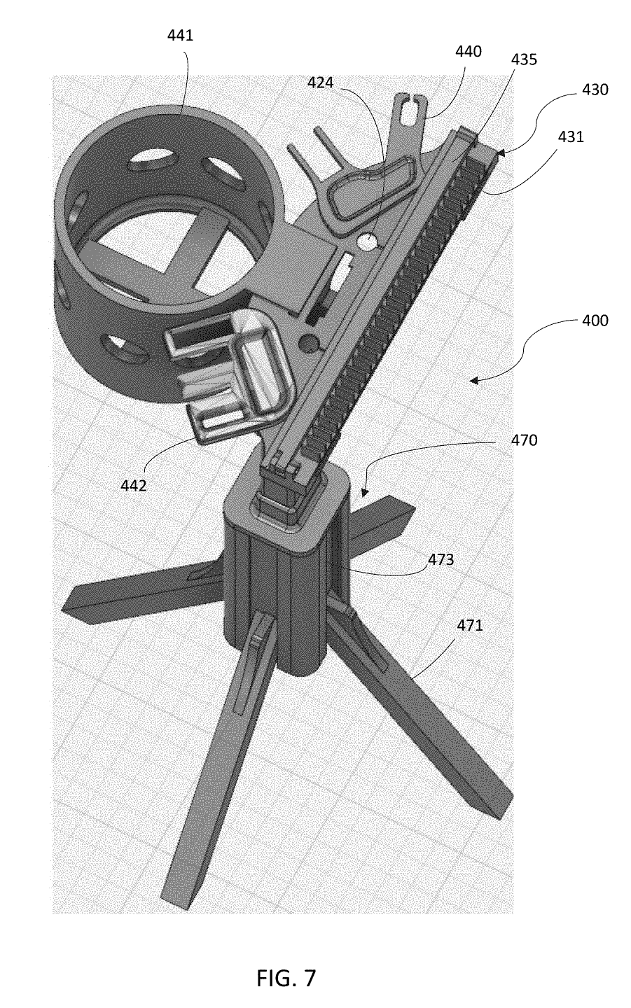

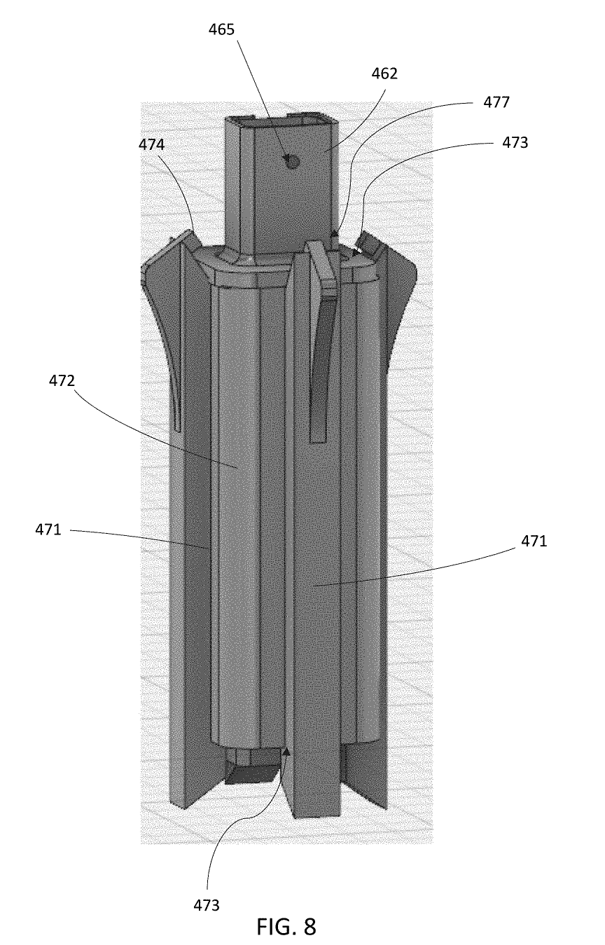

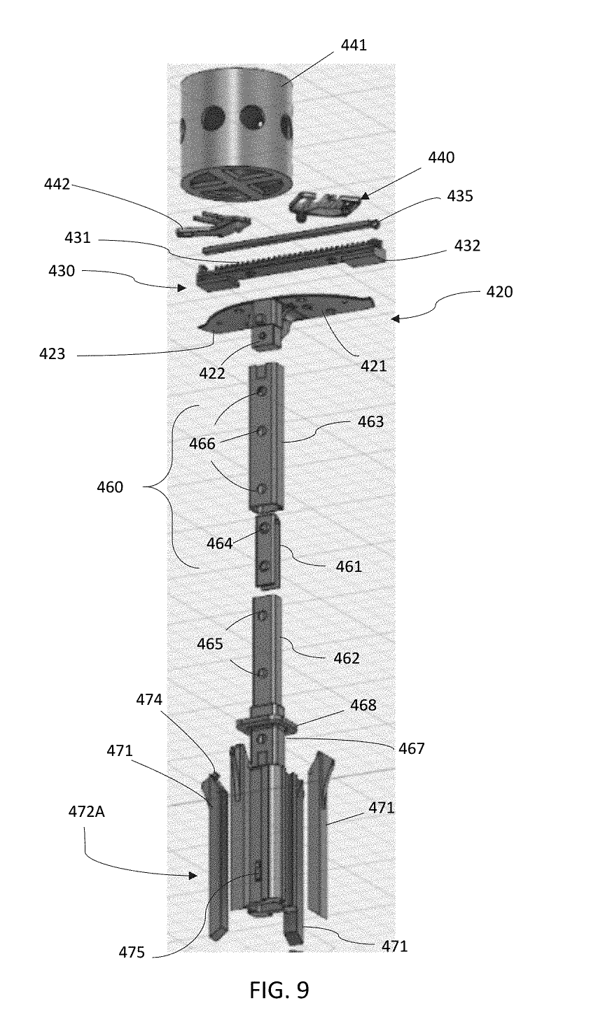

Referring to FIGS. 5-9, a further exemplary embodiment is provided and within the scope of the present disclosure. In this example, a hair stand or hairpiece stand 400 is shown that is adjustable and portable. Stand 400 includes several detachable parts that can be taken apart and reassembled. This makes for convenient portability and accessibility. Hairpiece stand 400 includes a base 470 which can be referred to synonymously as a support base. Base 470 includes a base body 472. In this example, base 470 is a retractable quad pod base that includes four extendable legs 471. These legs are configured to evenly surround base body 472 and extend outward when in a splayed configuration. Shown in FIG. 5, the legs are fully extended evenly away from base body 472 at a lower section 472A of base body 472. In this example, base body 472 defines an indented channel 473 on each side surrounding the base 470. The legs 471 are operable to fold inward sized and shaped to fit and slide upward into channels 473 that are formed to securely receive the legs 471. FIG. 8 shows the legs 471 securely and neatly fit into the channels 473 formed on base body 472. At the lower section 472A of base body 472, a receiving locking hole 475 is provided and adapted to receive a protrusion 474 that extends from a leg 471. Thus, when legs 471 are slid downward and extended outwardly to form a secure stand, the protrusion 474 engages the locking hole 475 to hold the legs into place in a splayed configuration. This allows for placement of the stand upon any surface, including a floor, a counter top, a table, and the like. In another embodiment, the base body 472 defines a plurality of vertically aligned locking holes within the channels 473 to allow for varying heights of the stand 400.

Stand 470 further includes a receiving opening 477 positioned at or near a top section 472B of the base body 472. Opening 477 is sized and shaped to receive neck extension 460. Neck extension 460 includes a plurality of detachable parts including a first adjustable neck extension 461 that engages with a second adjustable neck extension 462. An optional extra neck extension 463 can also be included in neck extension 460. First neck extension 461 includes a protruding retractable push button 464 adapted to engage any vertically aligned adjustment holes 465 formed on adjustable neck extension 462. Thus, the height of the hairpiece stand 400 can be adjusted by push button 464 and raising the stand to allow the button 464 to engage a higher or lower receiving hole 465. Similarly, extra neck extension 463 allows for further height adjustment of the hairpiece stand 400 using extra adjustment holes 466 that engage with additional push buttons 464 formed on first neck extension 461. A lower portion 467 of second neck extension 462 engages with the opening 477 of base body 472. A peripheral stop 468 can be provided to rest at or above a rim formed around the opening 477. The second neck extension 462 and optional extra neck extension 463 can be formed to have a hollow interior to allow for slidably adjusting up and down and engaging the first neck extension 461 therewithin.

Extending up and above neck extension 460 is a detachable top base 420. Top base 420 includes a relatively flat plate portion 421 having a plurality of mounting holes 424 for receiving additional components. In this example, top base 420 extends perpendicular and horizontal relative to a vertical axis defined by the extension 460. Top base 420 includes a connection piece 422 that detachably engages with neck extension 460. In this example, connection piece 422 is formed to engage with an opening formed in a top portion of extra neck extension 463.

Extending outwardly from plate 421 are a pair of relatively thinly profiled wing portions 423. The wing portions 423 are sized and shaped to receive a hairpiece rack 430 (also referred to a hair extension holder). Rack 430 includes a plurality of evenly spaced apart prongs or teeth 431 that extend upward and are configured to securely hold a hairpiece, extension, wig, or the like. Extending downwardly and underneath the holder prongs 431 is mounting feature 432 that includes a receiving channel 433. Receiving channel 433 is sized and shaped to securely receive wings 423 and securely rest on top of a portion of plate portion 421.

Rack 430 further includes a top clamp 435 that removably mounts over the holder prongs 431 to secure a hairpiece in place. Top clamp 435 includes end pieces that engage security clamps 434 positioned at the end of the holder prongs 431. This top clamp feature allows for securing a desired hairpiece and/or extension or the like in place to allow a user to style the hairpiece, clean it, treat it, modify it, or any other treatment desired by the user while still having use of both hands. The clamp should be tight enough to withstand normal tugging, pulling, and handling.

Further shown in the drawings are a variety of optional accessory pieces. These include a tool/accessory holder 441. In this example, holder 441 is shown as a cup having an opening and defining a plurality of holes. The holder 441 is mounted onto the top base 420 and is sized and shaped to receive a plurality of tools operable for use in treating a hairpiece. Examples of accessories that can be held by holder 441 include a blow dryer, combs, brushes, flat irons, curling irons, among other tools. Additional relatively small accessory holders 440 and 442 are shown for holding other desired tools or components such as a smaller hairpiece in holder 442 or hair pins, clips, and the like in holder 440. Top base 420 can be configured to hold a plurality of optional accessory pieces. As with other components of hair stand 400, these pieces are detachable and storable to facilitate convenient and effective storage and portability.

It should be noted that the steps described in the method of use can be carried out in many different orders according to user preference. The use of “step of” should not be interpreted as “step for”, in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application.

What is claimed is:

1. A stand for holding hairpieces for styling, the stand comprising:
(a) an extension having a height adjustment assembly and a height lock, the height adjustment assembly configured to lockably adjust between a plurality of heights;
(b) a base having an anti-skid surface, said anti-skid surface configured to limit lateral movement of the base across a floor, the base configured to statically position the height adjustment assembly on the floor; and
(c) a rack having (i) a hairpiece rack defining a plurality of spaced apart prongs extending upward, and (ii) a corresponding clamp configured to securely hold at least one hairpiece in place within the spaced apart prongs,
wherein the rack is coupled to the height adjustment assembly and the prongs extend along a horizontal length defined by the rack such that the at least one hairpiece is securely held in place during styling.

2. The stand of claim 1 wherein the top clamp is removably mounted above the hairpiece rack and the plurality of spaced apart prongs and operable to clamp down and secure a plurality of hairpieces in place between the plurality of prongs.

3. The stand of claim 1 wherein the base includes an extension receiver and the extension includes a rack receiver, wherein the extension receiver is removably-coupleable to the extension.

4. The stand of claim 3, wherein the base is configured to have a deployed state and a retracted state and wherein the retracted state is smaller than the deployed state.

5. The stand of claim 4, wherein the base is a support base and includes a plurality of legs operable to fold, collapse, and lock.

6. The stand of claim 5, wherein the plurality of legs includes four evenly spaced apart legs surrounding the base and slidably engaging corresponding receiving channels formed on sidewalls of the base, wherein the legs in an extended configuration extend down and outwardly away from the base forming a quad pod.

7. The stand of claim 1, wherein the extension includes concentric telescoping tubes configured to move between a minimum height and a maximum height.

8. The stand of claim 7 wherein the extension includes a push-button lock operable to lockably adjust between a plurality of heights by pushing a push-button lock of an inner tube and slidably extending or retracting the inner tube until the push-button lock extends out of one of a plurality of holes of an outer tube.

9. The stand of claim 1 wherein said rack is configured to securely retain a wig and alternately at least one section of a hair extension.

10. A portable hairpiece stand adapted to hold a plurality of hairpieces to allow for styling, the stand comprising:
(a) a top base defining a horizontal plate and a plurality of mounting holes operable for receiving one or more accessories;
(b) a hairpiece holder detachably mounted on the top base having a plurality of upwardly extending prongs and detachably engaged with a top clamp sized and shaped to hold a plurality of hairpiece between the prongs and the top clamp;
(c) an adjustable neck extension operable to adjust a height of the top base, the adjustable neck extension including a first adjustable portion movably engaged with a second adjustable portion via a plurality of adjustment holes aligned vertically and a push button formed on the first adjustable portion, the top base removably mounted to a top portion of the second adjustable portion through a connection piece; and
(d) a lower support base defining a mounting opening for receiving the adjustable neck extension, the lower support base defining one or more receiving channels for retracting and securely fitting a leg operable to slide downward and extend from a lower base body to rest onto a surface and adjust height of the stand.

11. The portable hairpiece stand of claim 10, wherein the lower support base defines an outer sidewall forming four receiving channels surrounding the lower support base and including four evenly spaced apart legs slidably engaging the corresponding receiving channels, wherein the legs in a splayed configuration extend down and outwardly away from the base forming a quad pod.

12. The portable hairpiece stand of claim 11, wherein the receiving channel further defines a receiving locking hole positioned at a lower section of the support base sized and shaped to a protrusion of the leg to hold the legs in a splayed configuration when the protrusion engages the locking hole.

13. The portable hairpiece stand of claim 12, further comprising a plurality of receiving locking holes aligned within the receiving channel to allow for height variation of the hairpiece stand.

14. The portable hairpiece stand of claim 10, wherein the top base, the adjustable neck, the hairpiece holder, and the lower support base are detachable from each other and operable to be reassembled.

15. The portable hairpiece stand of claim 10, wherein the horizontal plate includes a pair of wing portions for detachably engaging the hairpiece holder through a mounting feature of the hairpiece holder defining a wing portion receiving channel sized and shaped to slide over the wing portions of the horizontal plate.

16. The portable hairpiece stand of claim 10, further comprising a detachable tool and accessory holder mounted to the horizontal plate having an opening cavity for receiving a tool and a plurality of holes formed in a sidewall of the holder.

17. The portable hairpiece stand of claim 16, wherein the tool and accessory holder defines a cup configuration sized and shaped to receive a standard hair styling tool.

18. The portable hairpiece stand of claim 10, further comprising one or more small accessory holders mounted to the horizontal place through the mounting holes.

19. The portable hairpiece stand of claim 10, wherein the top clamp engages a security clamp located at an end of the hairpiece holder to hold the top clamp down when holding a hairpiece.
